(19) United States
(12) Patent Application Publication
(10) Pub. No.: US 2009/0238530 A1
(43) Pub. Date: Sep. 24, 2009

(54) Universal fiber distribution hub

(76) Inventors: George I. Wakileh, Batavia, IL (US); Jerome A. Maloney, Sugar Grove, IL (US); Simon Shen-Meng Chen, Palatine, IL (US); Eduardo Leon, Woodridge, IL (US)

Correspondence Address: HARNESS, DICKEY, & PIERCE, P.L.C, 7700 Bonhomme, Suite 400, ST. LOUIS, MO, 63105, US

(21) Appl. No.: 12/079,074

(22) Filed: Mar. 24, 2008

(51) Int. Cl. G02B 6/00

(52) U.S. Cl. 385/135

(57) ABSTRACT

A fiber distribution assembly includes a fiber distribution hub for housing a plurality of feeder fiber optic cables and distribution fiber optic cables. The fiber distribution hub is adapted for mounting in a telecommunications pedestal. A method of using a fiber distribution hub adapted for a plurality of different mounting configurations is also disclosed. The method includes offering for sale the fiber distribution hub for use in any one of the plurality of different mounting configurations.

### FIELD

The present disclosure relates to telecommunications fiber distribution hubs.

### BACKGROUND

The statements in this section merely provide background information related to the present disclosure and may not constitute prior art.

Fiber optic data transmission has become the state of the art method of transmitting data short and long distances. For example, optical data transmission systems are commonly implemented to communicate data and information throughout an office building, and also to transmit data and information between various locations separated by long distances. Over the past few years, the telecommunication industry, for example, has implemented massive communications networks by installing millions of miles of fiber optic communication lines throughout the world.

Various facilities, e.g., commercial, industrial and/or residential buildings, within such massive communication networks are often interconnected with each other or to a central office using fiber distribution hubs. A fiber distribution hub (FDH) is a metallic or a non-metallic enclosure that houses a plurality of feeder fibers and distribution fibers. Depending on the specific applications, the feeder fiber can either be split and then connected to a distribution side or connected directly, i.e. without splitting, to a distribution side of the FDH. From the distribution side of an FDH, distribution fibers leave the FDH and are routed to other locations.

As the name suggests, and FDH is a hub in a fiber optic telecommunications network. Numerous fiber optic cables, both feeder and distribution, enter and exit the enclosure. Generally, feeder fibers enter the distribution hub and distribution fibers exit the hub like spokes from a wheel. The FDH includes numerous components including optical splitters for dividing a single cable into multiple cables. Many connections and interconnections are made and housed within the FDH. The FDH is generally, therefore, a very large enclosure. An FDH is commonly a large, rectangular box. They are most commonly mounted outdoors on top of thick concrete pads or buried telecommunications vaults.

Closer to the point to which fiber is being delivered, the distribution fibers enter a distribution enclosure. The distribution enclosure is generally smaller than an FDH and is often mounted in a telecommunications pedestal. The distribution enclosure is the point where a customer drop is made. A distribution closure is commonly used for splicing fiber or terminating fiber for future use near the distribution enclosure.

### SUMMARY

According to one aspect of the present disclosure, a fiber distribution assembly includes a fiber distribution hub for housing a plurality of feeder fiber optic cables and distribution fiber optic cables. The fiber distribution hub is adapted for mounting in a telecommunications pedestal.

According to another aspect of the present disclosure, a method is provided for using a fiber distribution hub to receive feeder fiber optic cables and distributing fiber cable. The fiber distribution hub is adapted for a plurality of different mounting configurations. The method includes offering for sale the fiber distribution hub for use in any one of the plurality of different mounting configurations.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a front isometric view of a universal fiber distribution hub.

FIG. 2 is a front isometric view of a mounting plate for a universal fiber distribution hub.

FIG. 3a is an isometric view of a universal fiber distribution hub mounted in a distribution pedestal and having a mounting plate in a first position.

FIG. 3b is an isometric view of a universal fiber distribution hub mounted in a distribution pedestal and having a mounting plate in a second position.

FIG. 4 is a front isometric view of a universal fiber distribution hub configured for mounting on a wall.

FIG. 5 is a rear isometric view of a universal fiber distribution hub configured for mounting on a wall.

FIG. 6 is a rear isometric view of a universal fiber distribution hub in an alternate configuration for mounting on a wall.

FIG. 7 is a rear isometric view of a universal fiber distribution hub configured for mounting on a pole.

FIG. 8 is a front isometric view of a universal fiber distribution hub configured for mounting on a pad.

FIG. 9 is a rear isometric view of a universal fiber distribution hub configured for mounting on a vault.

FIG. 10 is a front isometric view of an alternate universal fiber distribution hub.

FIG. 11 is a front isometric view of an alternate mounting plate for a universal fiber distribution hub.

### DETAILED DESCRIPTION

The following description is merely exemplary in nature and is not intended to limit the present disclosure, application, or uses. It should be understood that throughout the drawings, corresponding reference numerals indicate like or corresponding parts and features.

A universal fiber distribution hub (UFDH) is a fiber distribution hub adapted for a plurality of different mounting configurations. A single UFDH can be configured to any one of the plurality of different mounting configurations. A different fiber distribution hub is not needed for each possible mounting configuration. The UFDH can be configured prior to providing the UFDH to the customer and/or after the customer has purchased or installed the UFDH. Kits can be offered that allow a customer to reconfigure the UFDH in the field. For example, a customer could purchase a UFDH configured to mount on a wall and later reconfigure and move the UFDH to a telecommunication pedestal. The reconfiguration of the UFDH can often be accomplished without removing and reinstalling the feeder and distribution cables installed in the UFDH. According to some embodiments, the UFDH is designed to meet or exceed GR-771 Telcordia requirements for fiber optic splice closures.

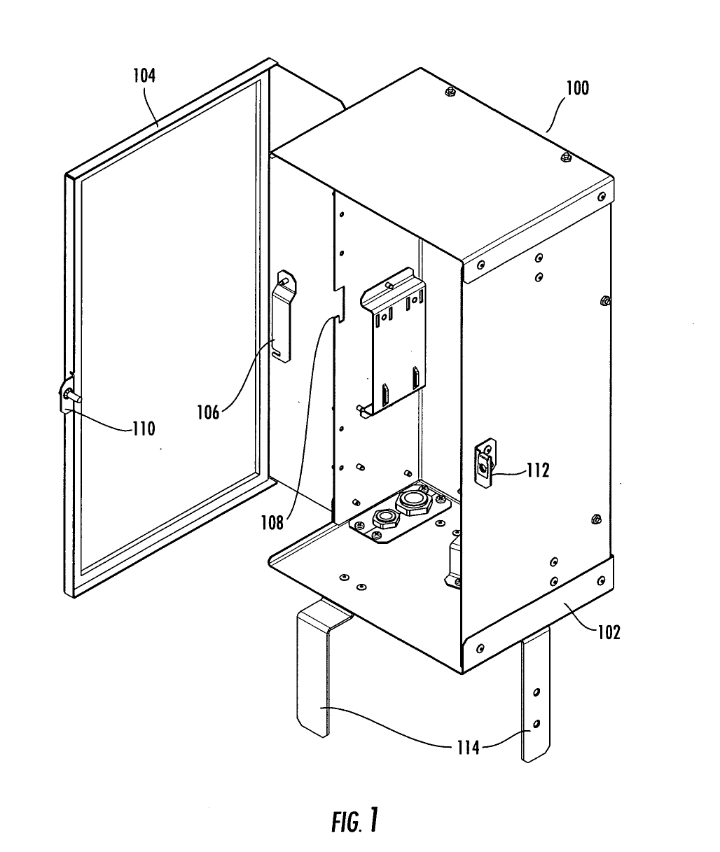

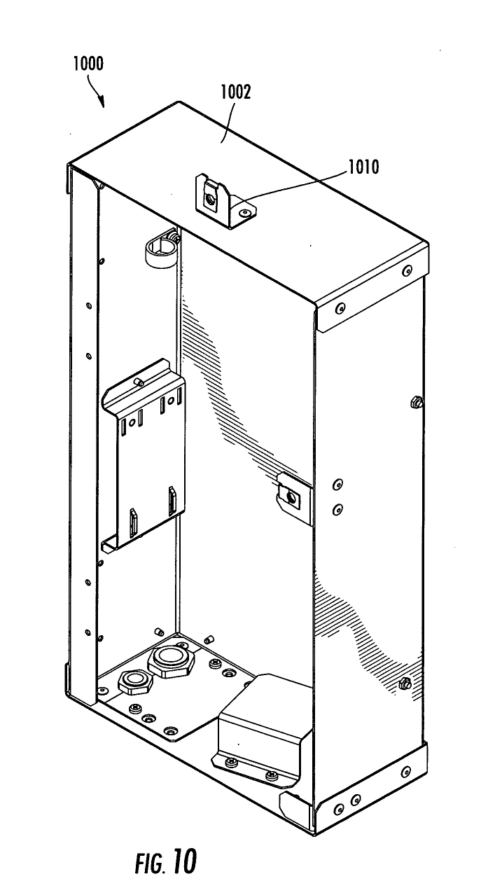

A universal fiber distribution hub (UFDH), generally indicated by reference numeral 100, is illustrated in FIG. 1. The UFDH has a rectangular box shape and is generally, but not always, smaller than fiber distribution hubs common in the industry. When the UFDH is installed in a location, the UFDH houses a plurality of feeder fiber optic cables and distribution fiber optic cables (not shown). The UFDH includes a housing portion 102 in which such cables and additional cable routing, management and distribution elements are housed. A door 104 is attached to the housing portion of the UFDH. The door is attached to the housing portion by hinge that allows the door to open and close to enclose and protect the contents of the UFDH. The door includes a wind latch 106. The wind latch is mounted on the door so as to be rotatable to engage the wind latch catch 108 on the housing portion of the UFDH. When engaged with the wind latch catch, the wind latch prevents the door from opening or closing any further. The door also includes a door latch 110. The door latch engages a door catch 112 to keep the door in a closed position. Alternatively, the UFDH can omit the door entirely. FIG. 10 illustrates an alternately shaped UFDH 1000 including only a housing portion 1002. As can be seen at least by the inclusion of a door latch 1010, the UFDH 1000 can include a door if desired. The inclusion or omission of the door is determined by the level of protection desired by the user of the UFDH. According to some embodiments, the UFDH is a weather tight fiber distribution hub closure.

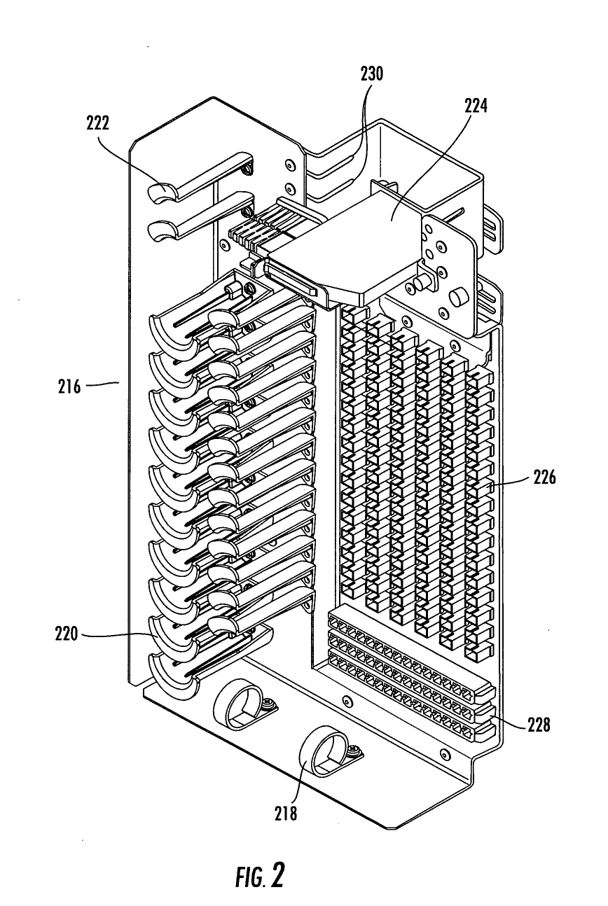

In some example embodiments the UFDH includes a mounting plate 216. One such a mounting plate is illustrated in FIG. 2. The mounting plate includes cable routing elements such as cable guides 218 and half spools 220 and crescent spools 222. The cable routing elements are used when installing fiber optic cable in the UFDH with the mounting plate installed within. The routing elements retain the fiber optic cable and direct it around the UFDH and the mounting plate. For example, fiber optic feeder cables can be routed through the cable guides 218, around a bottommost half spool and up the leftmost side of the mounting plate. When the feeder cable reaches the top of the mounting plate, the cable can be routed around one of the crescent spools and directly into a fiber optic cable splitter 224. The splitter is illustrated for clarity and is not a part of the mounting plate. The fiber optic cable splitter receives a distribution fiber and provides a larger number of fiber optic cables for distribution or connection.

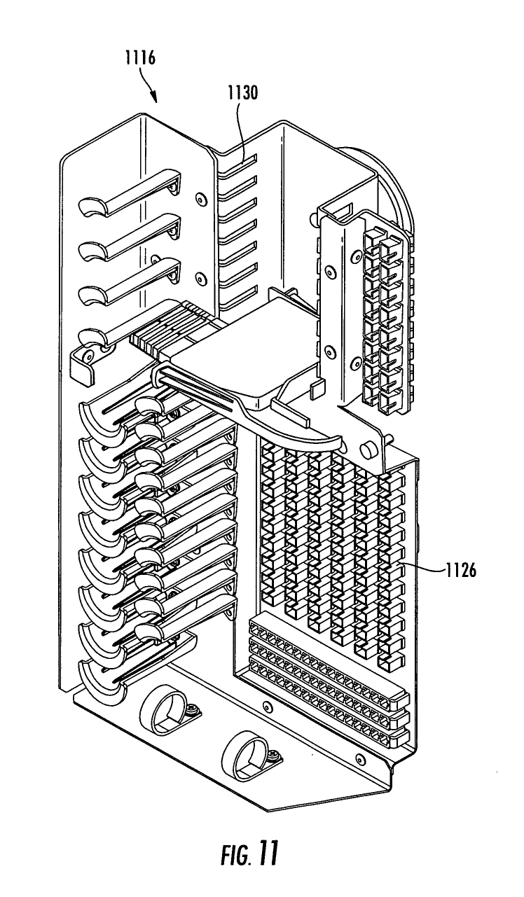

The cables exiting the splitter can be routed around the half spools and crescent spools and to various connection points 226 on the mounting plate. Cables that are not to be used immediately can be routed around the half spools and crescent spools to connection to parking points 228 The mounting plate illustrated in FIG. 2 includes 96 connection points and 48 parking points. The mounting plate also has mounting slots 230 for receiving up to three optical splitters. In other embodiments, the mounting plate has slots for receiving two or four optical splitters or 72 or 144 connection points. It should be recognized, however, that configurations with more or fewer connection points, parking points and optical splitters are possible and the mounting plate is not limited to any one such a configuration. For example, FIG. 11 illustrates an alternate mounting plate 1116 having 72 connection points 1126 and eight pairs of mounting slots 1130 to receive up to eight optical splitters.

Additional features are included in the mounting plate according to other embodiments. For example, the mounting plate may include a splitter parking lot. A splitter parking lot permits docking of unused splitter ports. The mounting plate may also include pass through ports that permit the splitter to be bypassed in high bandwidth applications. Additional embodiments can also include pre-terminated dielectric loose tube feeder and distribution cable stubs.

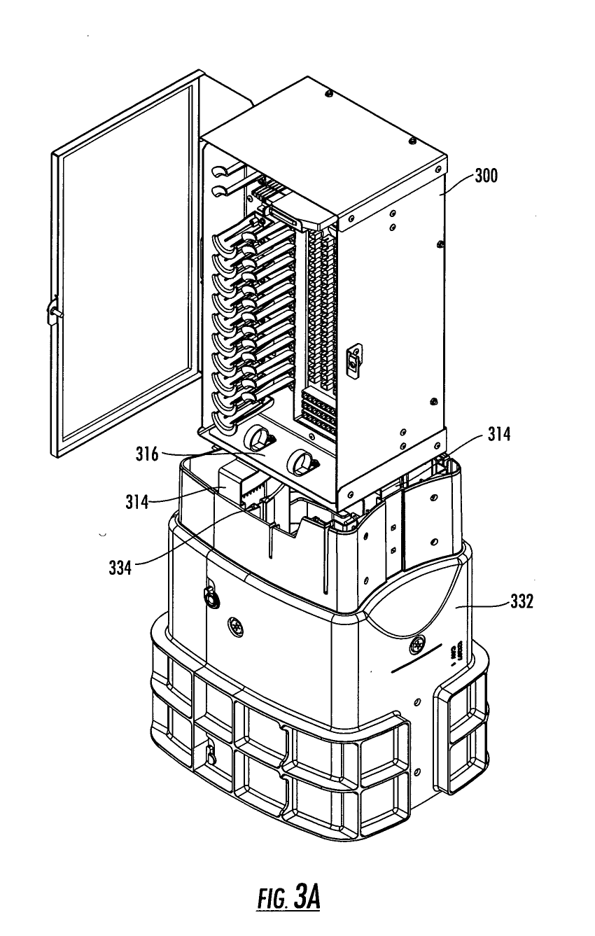

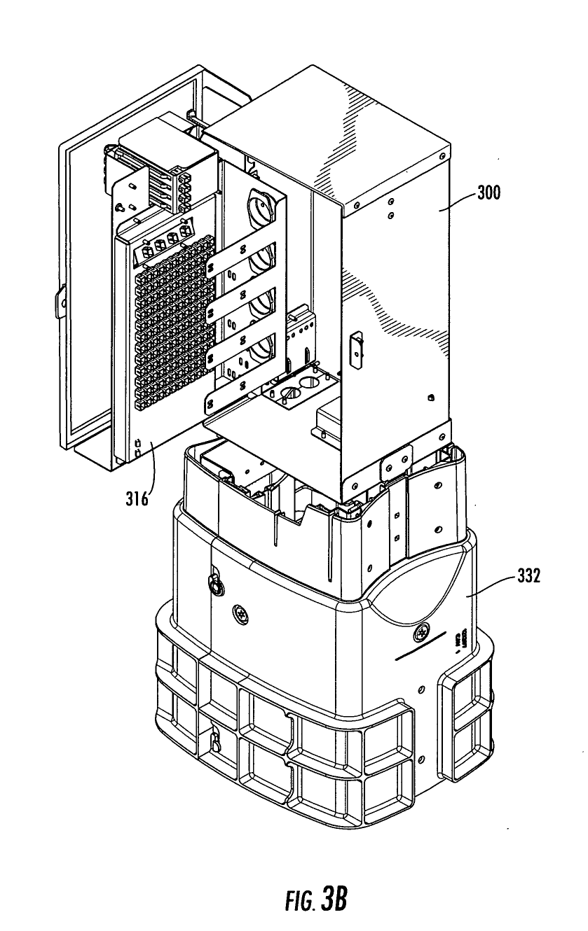

The mounting plate is attached to the UFDH by hinges. As illustrated in FIGS. 3a and 3b, the mounting plate can swing in and out of the housing portion of the UFDH. This allows an installer or technician to access both the front and the back of the mounting plate through one door. In various figures discussed hereinafter, the UFDH is illustrated with the mounting plate installed in the UFDH.

The UFDH can be used in numerous ways. The UFDH can be mounted, for example, in a telecommunications pedestal, on a concrete pad, on a buried telecommunications vault, on a wall or on a pole. The UFDH may also be used in direct buried applications without a concrete, or other material, pad or vault. The UFDH is illustrated in FIG. 1 configured for mounting in a telecommunications pedestal. Mounting legs 114 are attached to the bottom of the UFDH. These legs are received by matching slots in a telecommunications pedestal. Thus, the UFDH can be mounted in a telecommunications pedestal by lowering the UFDH onto the pedestal while aligning the legs of the UFDH with the slots of the pedestal. This and other mounting configurations are further illustrated by subsequent figures and will be discussed further below.

A UFDH 300 with a mounting plate 316 installed is illustrated mounted in a distribution pedestal 332 in FIG. 3a. The legs 314 of the UFDH are shown fully inserted into the mounting slots 334 of the distribution pedestal. Such a mounting configuration tends to be more compact than standard fiber distribution hubs. This configuration also allows a distribution pedestal cover, not shown, to be placed over the UFDH and attached to the distribution pedestal. Such covers, provide additional protection for the UFDH and the fiber optic cable and connections within the UFDH. According to some embodiments, a UFDH mounted in a distribution pedestal includes flood proof and environmental protection.

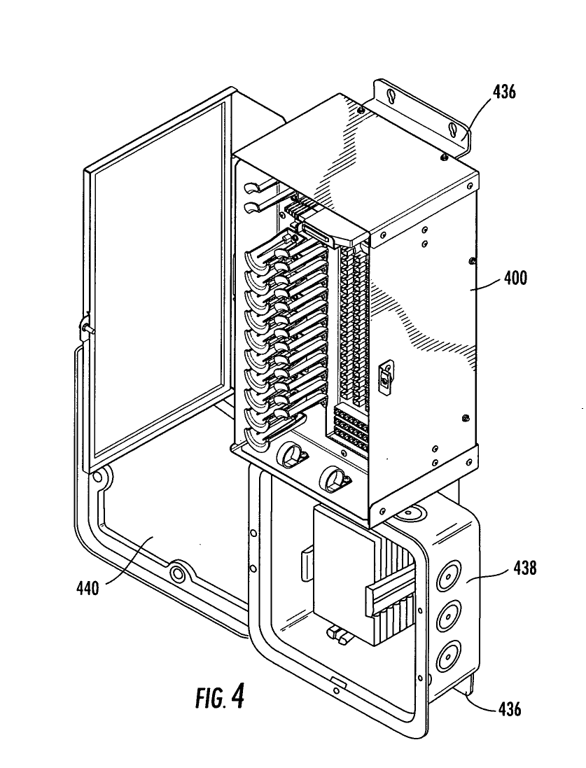

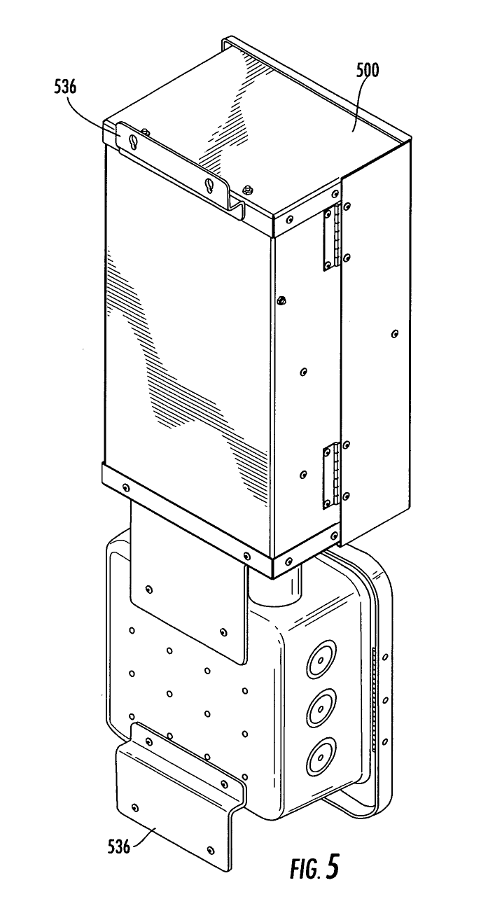

FIG. 4 illustrates on wall mounting configuration of the UFDH 400. The UFDH does not have legs mounted on the bottom the housing portion, but instead has wall mounting brackets 436 installed on the back of the housing portion. The UFDH is attached to a wall using these mounting brackets and appropriate screws, bolts, lags, etc. A rear isometric view of a UFDH 500 configured for wall mounting is shown in FIG. 5. In this rear view, the wall mounting brackets 536 can be more clearly seen.

The UFDH in FIG. 4 also includes a removably attached splice closure 438 including a closable door 440. The splice closure provides a separate closable enclosure for splicing and microduct applications. The splice closure can include splice trays for splicing cable. When used for microduct applications, empty microduct tubes are brought from a location and into the splice closure. Fiber optic cables can be routed from the UFDH to the location through the microduct tubes. The splice closure provides a centralized distribution point for the fibers going to and from the location.

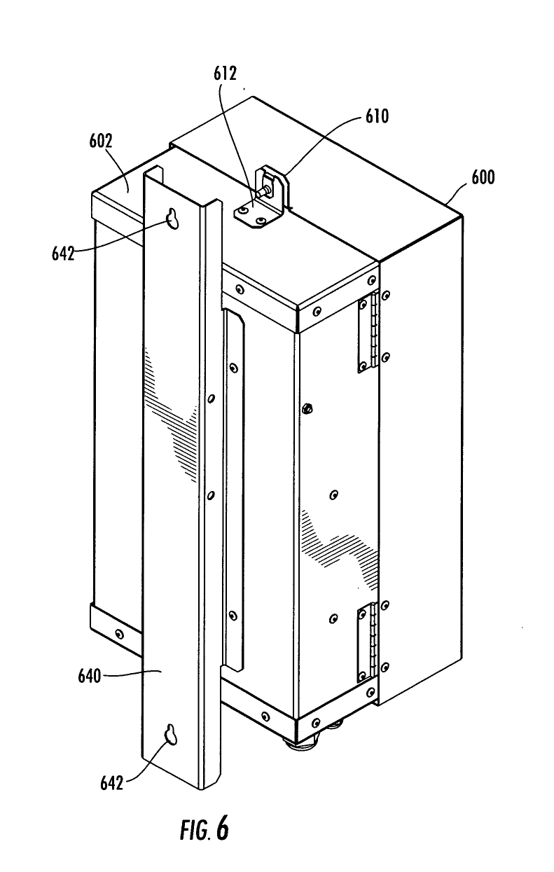

FIG. 6 illustrates a rear isometric view of an UFDH 600 configured for wall mounting. The UFDH includes a single rear mounting bracket 640 attached to the rear of the housing portion 602. The bracket allows the UFDH to be mounted to a wall using appropriately sized fasteners through the holes 642. The UFDH in FIG. 6 also includes a door latch 610 on the top side of the door 604 and a door catch 612 mounted on the housing portion 602.

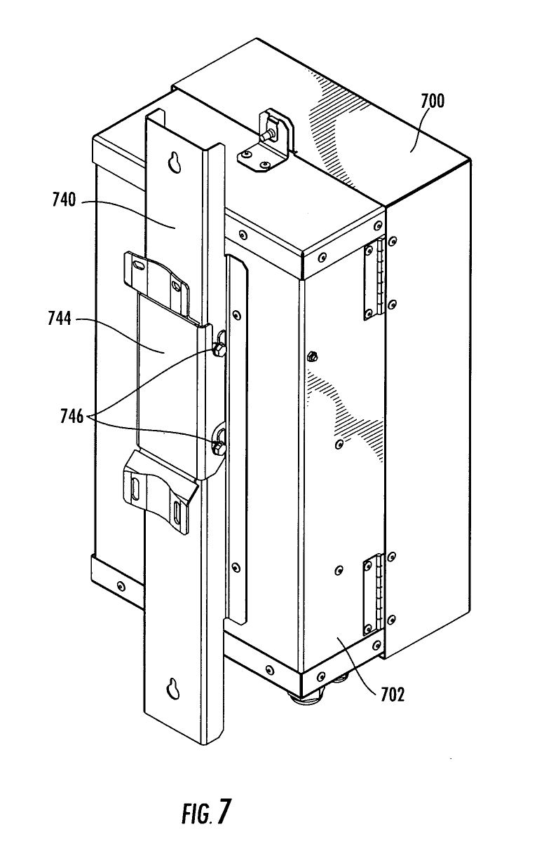

The UFDH can also be configured for mounting on a pole as illustrated in FIG. 7. A single rear mounting bracket 740 is attached to the rear of the housing portion 702 of the UFDH. To accommodate the round shape of a pole, however, a pole mounting bracket 746 attached to a pole and the pole mounting bracket is attached to the mounting bracket 740 via fasteners 746. The fasteners can be any appropriate fastener such as screws or bolts.

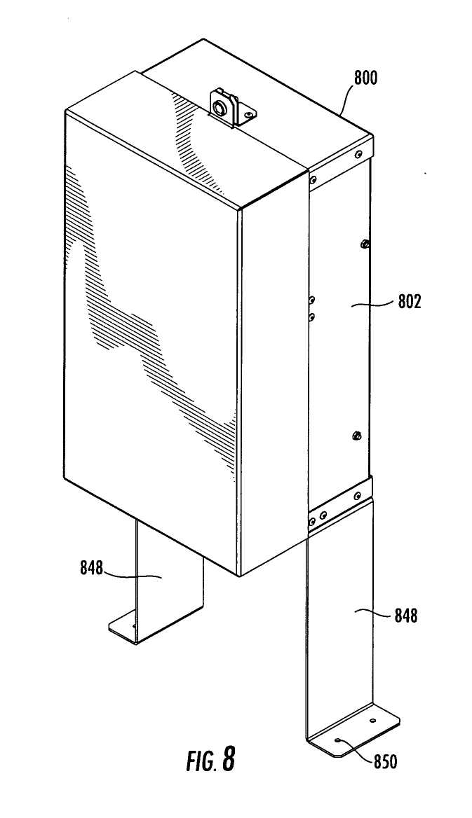

FIG. 8 shows a front isometric view of a UFDH 800 for mounting on a concrete pad. Similar to the pedestal configuration of FIG. 1, the UFDH 800 includes legs 848 attached to the bottom of a body portion 802 of the UFDH. These legs 848, however, are designed to be attached to a concrete pad. The legs are connected to the concrete pad by fasteners through the holes 850 in the legs.

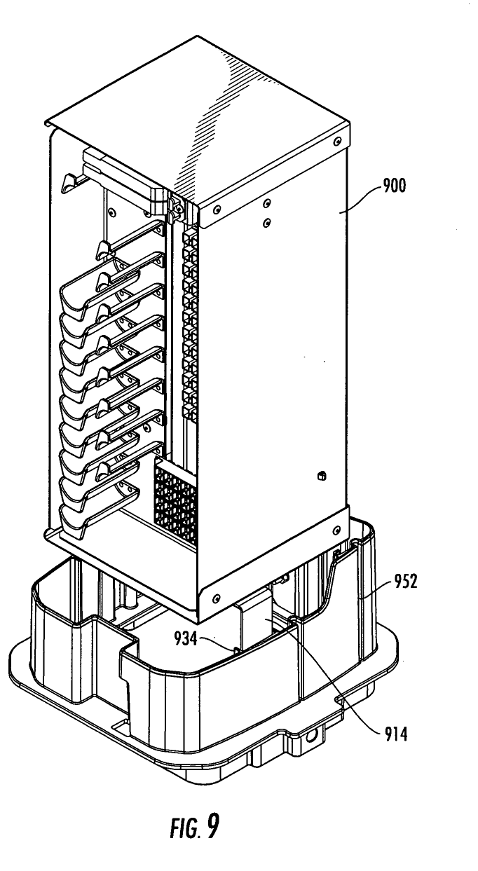

A UFDH 900 configured for mounting on a telecommunications vault is illustrated in FIG. 9. A vault mounting base 952 is attached to the bottom of the UFDH. The vault mounting base allows the UFDH to be bolted to the top of a precast vault having an appropriate cutout in which the mounting base can fit. The vault mounting base is attached to the UFDH in a manner similar to the mounting of the UFDH 300 to the pedestal 332 in FIG. 3. The vault mounting base includes slots 934 for receiving legs 914 attached to the UFDH. Like the pedestal 332, the vault mounting base is capable of receiving a dome cover so that the UFDH may be enclosed and covered for additional protection.

The description herein is merely exemplary in nature and, thus, variations that do not depart from the gist of that which is described are intended to be within the scope of the teachings. Such variations are not to be regarded as a departure from the spirit and scope of the teachings.

1. A fiber distribution assembly comprising a fiber distribution hub for housing a plurality of feeder fiber optic cables and distribution fiber optic cables, the fiber distribution hub adapted for mounting in a telecommunications pedestal.

2. The fiber distribution assembly of claim 1 wherein the fiber distribution hub is further adapted for mounting on a wall.

3. The fiber distribution assembly of claim 1 wherein the fiber distribution hub is further adapted for mounting on a pad.

4. The fiber distribution assembly of claim 1 wherein the fiber distribution hub is further adapted for mounting on a vault.

5. The fiber distribution assembly of claim 1 wherein the fiber distribution hub is further adapted for mounting on a pole.

6. The fiber distribution assembly of claim 1 wherein the fiber distribution hub is further adapted for mounting on a wall, a pad, a vault and a pole.

7. The fiber distribution assembly of claim 1 further comprising a mounting plate attached to the fiber distribution hub, the mounting plate adapted for supporting a plurality of fiber distribution components and operable to move between a first position and a second position, a front face of the mounting plate accessible at least when the mounting plate is in the first position and a rear face of the mounting plate accessible at least when the mounting plate is in the second position.

8. The fiber distribution assembly of claim 7 wherein the fiber distribution hub is configured to permit the mounting plate to move between the first and second positions without removing cable when cable is connected to the mounting plate.

9. The fiber distribution assembly of claim 7 further comprising cable management elements configured to permit the mounting plate to swing between the first and second positions without interference from cable mounted in the fiber distribution hub.

10. The fiber distribution assembly of claim 1 further comprising a telecommunications pedestal, the fiber distribution hub mounted on the pedestal.

11. The fiber distribution assembly of claim 10 wherein the fiber distribution hub is mounted on the pedestal via at least one leg attached to the fiber distribution hub.

12. The fiber distribution assembly of claim 10 further comprising at least one feeder fiber optic cable and at least one distribution fiber optic cable mounted in the fiber distribution hub.

13. A method of providing a fiber distribution hub for receiving feeder fiber optic cables and distributing fiber cable, the fiber distribution hub adapted for a plurality of different mounting configurations, the method comprising offering for sale the fiber distribution hub for use in any one of the plurality of different mounting configurations.

14. The method of claim 13 further comprising configuring the fiber distribution hub for one of the plurality of different mounting configurations in response to a customer request.

15. The method of claim 14 wherein configuring includes installing at least one mounting bracket on the fiber distribution hub.

16. The method of claim 13 further comprising offering at least one mounting bracket for adapting the fiber distribution hub for use in at least one of the plurality of different mounting configurations.

17. The method of claim 14 further comprising offering at least one mounting bracket for adapting the configured fiber distribution hub for use in another of the plurality of different mounting configurations.

18. The method of claim 13 wherein the plurality of different mounting configurations include at least two of a pedestal mounting configuration, a wall mounting configuration, a pole mounting configuration, a pad mounting configuration and a pedestal mounting configuration.

19. The method of claim 14 further comprising reconfiguring the fiber distribution hub for another of the plurality of different mounting configurations after the fiber distribution hub has been installed in a first mounting configuration.

20. The method of claim 19 wherein the installed fiber distribution hub includes a plurality of fiber optic feeder and distribution cables installed in the fiber distribution hub and wherein reconfiguring the fiber distribution hub is performed without removing the feeder and distribution cables.
